(19) United States
(12) Patent Application Publication
(10) Pub. No.: US 2020/0313823 A1
(43) Pub. Date: Oct. 1, 2020

(54) Method and Apparatus for Indicating Transmission Position of Reference Signal Resource and Communication System

(71) Applicant: FUJITSU LIMITED, Kawasaki-shi (JP)

(72) Inventors: Guoyu ZHANG, Beijing (CN); Xin WANG, Beijing (CN); Lei ZHANG, Beijing (CN); Lei SONG, Beijing (CN); Zhe CHEN, Beijing (CN)

(73) Assignee: FUJITSU LIMITED, Kawasaki-shi (JP)

(21) Appl. No.: 16/903,459

(22) Filed: Jun. 17, 2020

Related U.S. Application Data
(63) Continuation of application No. PCT/CN2018/076725, filed on Feb. 13, 2018.

(51) Int. Cl. H04L 5/00; H04W 72/04; H04B 7/06; H04W 24/10

(52) U.S. Cl. CPC H04L 5/0048; H04W 72/0446; H04W 24/10; H04W 72/042; H04B 7/0626; H04L 5/0094

(57) ABSTRACT

A method and apparatus for indicating a transmission position of a reference signal resource and a communication system. The method includes: a network device transmits first configuration information to a terminal equipment, the first configuration information indicating reference signal resources configured in a reference signal resource set being transmitted within one or more time intervals, wherein the reference signal resources are allocated in the one or more time intervals. Hence, it may be ensured that when the number of aperiodic reference signal resources needed in one time of measurement is relatively large, reference signal resources in a reference signal resource set being transmitted within multiple time intervals may be indicated. And the terminal equipment may select appropriate reference signal resources based on the configuration of the network device and report the reference signal resource indicators (CRIs) to the network device.

### CROSS REFERENCE TO RELATED APPLICATIONS

This application is a continuation application of International Application No. PCT/CN2018/076725, filed on Feb. 13, 2018, the contents of which are incorporated herein by reference.

### FIELD

This disclosure relates to the field of communication technologies, and in particular to a method and apparatus for indicating a transmission position of a reference signal resource and a communication system.

### BACKGROUND

It is provided in the new radio (NR) standards that when aperiodic channel state information reference signal (CSI-RS) resources are used for report of aperiodic channel state information (CSI), the network device will configure a time offset X for each CSI-RS resource set via a high layer configuration parameter AperiodicNZP-CSI-RS-TriggeringOffset. The time offset X is defined as a time interval between a time when triggering signaling of the aperiodic CSI-RS resource set is transmitted and a time when a CSI-RS is transmitted by using a CSI-RS resource in the aperiodic CSI-RS resource set, and the time interval may be in unit of slot.

The NR standards supports that the maximum number of CSI-RS resources included in a CSI-RS set does not exceed 64. Furthermore, it is provided in the NR standards that each triggering state in the triggering signaling may only trigger one resource set in the same CSI resource configuration (CSI-ResourceConfig).

Furthermore, the configuration on resource set further contains a parameter repetition. When this parameter is set to be “ON”, the terminal equipment deems that transmission beams used by the network device side in transmitting resources in the resource set are identical; and when the parameter is set to be “OFF”, the terminal equipment does not deem that transmission beams used by the network device side in transmitting resources in the resource set are identical. Such a configuration mode may achieve process 2 and process 3 of beam management, that is, the beam refining at the network device side and the terminal equipment side.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

However, it was found by the inventors that when aperiodic CSI-RS resources are used for beam sweeping, if the number of CSI-RS resources included in the aperiodic resource set is relatively large, transmission is unable to be performed in orthogonal frequency division multiplexing (OFDM) symbols included in one slot, or the number of CSI-RS resources exceeds an upper limit of the number of times of switching beams by the terminal equipment in one slot. It still needs to be discussed whether aperiodic CSI-RS resources triggered by the same triggering state for the same carrier frequency occupy multiple slots is supported.

In addition, if this mechanism is supported, this mechanism may also implement the process 1 of beam management, that is, determining beams at the network device side and the terminal equipment side. At this time, feedback contents of the terminal equipment are different for different application scenarios. How to distinguish different application scenarios so that the terminal equipment reports corresponding contents also needs to be resolved.

Embodiments of this disclosure provide a method and apparatus for indicating a transmission position of a reference signal resource and a communication system, in which beam management and CRI report of a terminal equipment are performed when abilities of the terminal equipment are limited.

According to a first aspect of the embodiments of this disclosure, there is provided a method for indicating a transmission position of a reference signal resource, including:

a network device transmits first configuration information to a terminal equipment, the first configuration information indicating reference signal resources configured in a reference signal resource set being transmitted within one or more time intervals, wherein the reference signal resources are allocated in the one or more time intervals.

According to a second aspect of the embodiments of this disclosure, there is provided an apparatus for indicating a transmission position of a reference signal resource, configured in a network device, the apparatus including:

a first transmitting unit configured to transmit first configuration information to a terminal equipment, the first configuration information indicating reference signal resources configured in a reference signal resource set being transmitted within one or more time intervals, wherein the reference signal resources are allocated in the one or more time intervals.

According to a third aspect of the embodiments of this disclosure, there is provided a method for reporting reference signal resource indicators (CRIs), including:

a terminal equipment receives first configuration information transmitted by a network device, the first configuration information indicating reference signal resources configured in a reference signal resource set being transmitted within one or more time intervals, wherein the reference signal resources are allocated in the one or more time intervals; and

the terminal equipment selects the reference signal resources based on the first configuration information, and reports CRIs to the network device.

According to a fourth aspect of the embodiments of this disclosure, there is provided an apparatus for reporting reference signal resource indicators (CRIs), including:

a receiving unit configured to receive first configuration information transmitted by a network device, the first configuration information indicating reference signal resources configured in a reference signal resource set being transmitted within one or more time intervals, wherein the reference signal resources are allocated in the one or more time intervals; and

a reporting unit configured to select the reference signal resources based on the first configuration information, and report CRIs to the network device.

According to a fifth aspect of the embodiments of this disclosure, there is provided a communication system, including:

a network device including the apparatus as described in the second aspect; and

a terminal equipment including the apparatus as described in the fourth aspect.

An advantage of the embodiments of this disclosure exists in that the network device transmits first configuration information to the terminal equipment, the first configuration information indicating reference signal resources configured in a reference signal resource set being transmitted within one or more time intervals, wherein the reference signal resources are allocated in the one or more time intervals. Hence, it may be ensured that when the number of aperiodic reference signal resources needed on one time of measurement is relatively large, reference signal resources in a reference signal resource set being transmitted within multiple time intervals may be indicated. And the terminal equipment may select appropriate reference signal resources based on the configuration of the network device and report the reference signal resource indicators (CRIs) to the network device.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of a communication system of an embodiment of this disclosure;

FIG. 2 is a schematic diagram of the method for indicating a transmission position of a reference signal resource of Embodiment 1 of this disclosure;

FIG. 3 is an exemplary diagram of the aperiodic CSI-RS resource set of Embodiment 1 of this disclosure;

FIG. 4 is a schematic diagram of the method for reporting CRIs of Embodiment 2 of this disclosure;

FIG. 5 is another exemplary diagram of the aperiodic CSI-RS resource of Embodiment 2 of this disclosure;

FIG. 6 is a further exemplary diagram of the aperiodic CSI-RS resource of Embodiment 2 of this disclosure;

FIG. 7 is yet another exemplary diagram of the aperiodic CSI-RS resource of Embodiment 2 of this disclosure;

FIG. 8 is still another exemplary diagram of the aperiodic CSI-RS resource of Embodiment 2 of this disclosure;

FIG. 9 is a schematic diagram of the apparatus for indicating a transmission position of a reference signal resource of Embodiment 3 of this disclosure;

FIG. 10 is a schematic diagram of the apparatus for reporting CRIs of Embodiment 4 of this disclosure;

FIG. 11 is a schematic diagram of the network device of Embodiment 5 of this disclosure;

and

FIG. 12 is a schematic diagram of the terminal equipment of Embodiment 5 of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, and/or other communication protocols that are currently known or will be developed in the future.

In the embodiments of this disclosure, the term “network device”, for example, refers to a device in a communication system that accesses a terminal equipment to the communication network and provides services for the terminal equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC).

The base station may include but not limited to a node B (NodeB or NB), an evolved node B (eNodeB or eNB), and a 5G base station (gNB). Furthermore, it may include a remote radio head (RRH), a remote radio unit (RRU), a relay, or a low-power node (such as a femto, and a pico). The term “base station” may include some or all of its functions, and each base station may provide communication coverage for a specific geographical area. And a term “cell” may refer to a base station and/or its coverage area, which is dependent on a context of the term.

In the embodiments of this disclosure, the term “user equipment (UE)” or “terminal equipment (TE)” refers to, for example, equipment accessing to a communication network and receiving network services via a network device. The user equipment may be fixed or mobile, and may also be referred to as a mobile station (MS), a terminal, a subscriber station (SS), an access terminal (AT), or a station, etc.

The user equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal.

Furthermore, the term “network side” or “network device side” refers to a side of the network, which may be a base station, and may include one or more of the above network devices. And the term “user side” or “user equipment side” refers to a side of the user or terminal, which may be a UE, and may include one or more of the above terminal equipments.

Scenarios in the embodiments of this disclosure shall be described below by way of examples; however, this disclosure is not limited thereto.

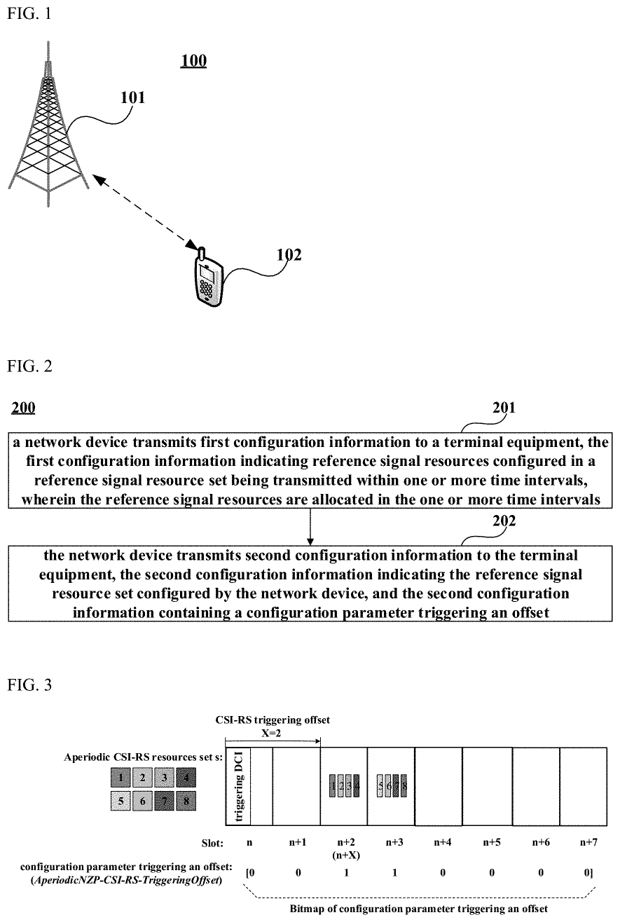

FIG. 1 is a schematic diagram of a communication system of an embodiment of this disclosure, in which a case where a terminal equipment and a network device are taken as examples is schematically shown. As shown in FIG. 1, a communication system 100 may include a network device 101 and a terminal equipment 102. For the sake of simplicity, description is given in FIG. 1 by taking one terminal equipment and a network device only as an example; however, the embodiments of this disclosure are not limited thereto.

In the embodiment of this disclosure, existing traffics or traffics that may be implemented in the future may be performed between the network device 101 and the terminal equipment 102. For example, such traffics may include but not limited to an enhanced mobile broadband (eMBB), massive machine type communication (MTC), and ultra-reliable and low-latency communication (URLLC).

The embodiments of this disclosure shall be described by taking an NR system as an example; however, this disclosure is not limited thereto, and it is also applicable to other systems in which similar problems exist. Furthermore, the embodiments of this disclosure shall be described by taking an aperiodic CSI-RS as an example; however, this disclosure is not limited thereto, and it is also applicable to other reference signals or other scenarios.

### Embodiment 1

The embodiment of this disclosure provides a method for indicating a transmission position of a reference signal resource.

FIG. 2 is a schematic diagram of the method for indicating a transmission position of a reference signal resource of the embodiment of this disclosure, in which a situation at a network device side is shown. As shown in FIG. 2, a method 200 for indicating a transmission position of a reference signal resource includes:

step 201: a network device transmits first configuration information to a terminal equipment, the first configuration information indicating reference signal resources configured in a reference signal resource set being transmitted within one or more time intervals, wherein the reference signal resources are allocated in the one or more time intervals.

In this embodiment, the reference signal resource is an aperiodic channel state information reference signal (CSI-RS) resource, and the above time interval may be a time interval constituted by slots, frames, subframes, or other time units. That is, in one time of triggering of the aperiodic reference signal resource set, the aperiodic CSI-RS resources configured in the aperiodic reference signal resource set may span multiple time intervals, that is, they are configured in multiple time intervals for transmission. Hence, it may be ensured that when the number of aperiodic reference signal resources needed in one time of measurement is relatively large, reference signal resources in a reference signal resource set being transmitted within multiple time intervals may be indicated.

In one implementation, the first configuration information is a bitmap of N bits, and the N bits of the bitmap represent consecutive N time intervals starting from a time interval where signaling triggering transmission of the above reference signal resource set (triggering signaling) is located; wherein a bit set to be of a predetermined value in the bit bitmap indicates that at least one reference signal resource in the above reference signal resource set is transmitted within a time interval represented by the bit set to be of a predetermined value.

In this implementation, the bit set to be of a predetermined value is, for example, bit “1”. However, this embodiment is not limited thereto, and the bit set to be of a predetermined value may also be “0” or another specific value. In addition, the number of reference signal resources transmitted in the time interval represented by the bit set to be of a predetermined value is dependent on the total number of reference signal resources configured in the reference signal resource set and the number of bits set to be of the predetermined value in the bitmap. For example, the number of reference signal resources transmitted within the time interval represented by the bits set to be of the predetermined value may be

$$\frac{K}{{N}_{one}} ,$$

or may be

$$⌈ \frac{K}{{N}_{one}} ⌉ \text{and/or} K - ( {N}_{one} - 1 ) ⌈ \frac{K}{{N}_{one}} ⌉ ;$$

where, K is the number of the reference signal resources configured in the reference signal resource set, and Nₒₙₑ is the number of bits set to be of a predetermined value in the bitmap.

For example, when

$$\frac{K}{{N}_{one}}$$

is an integer, the numbers of reference signal resources transmitted within the time interval in which the reference signal resources are transmitted, both are

$$\frac{K}{{N}_{one}} .$$

For another example, when

$$\frac{K}{{N}_{one}}$$

is not an integer, the number of reference signal resources transmitted within other time intervals than the last time interval in which the reference signal resources are transmitted is

$$⌈ \frac{K}{{N}_{one}} ⌉ ,$$

and the number of reference signal resources transmitted within the last time interval in which the reference signal resources are transmitted is

$$K - ( {N}_{one} - 1 ) ⌈ \frac{K}{{N}_{one}} ⌉ .$$

In this implementation, as shown in FIG. 2, the method 200 for indicating a transmission position of a reference signal resource may further include:

step 202: the network device transmits second configuration information to the terminal equipment, the second configuration information indicating the reference signal resource set configured by the network device, and the second configuration information containing a configuration parameter triggering an offset, that is AperiodicNZP-CSI-RS-TriggeringOffset; and the first configuration information is configuration for the configuration parameter triggering an offset.

In this implementation, an order of execution of steps 201 and 202 is not limited.

FIG. 3 is a schematic diagram of transmission of reference signal resources configured in the reference signal resource set spanning two slots. In the example of FIG. 3, description is given by taking that the reference signal resource set is a CSI-RS resource set s and K=8 aperiodic CSI-RS resources are configured in the CSI-RS resource set s as an example. As shown in FIG. 3, the triggering offset X=2, the bitmap is configured as “00110000”, and the predetermined value is “1”, that is, Nₒₙₑ=2, indicating that the CSI-RS resources in the CSI-RS resource set s are transmitted in a third slot and a fourth slot calculated starting from a slot in which the DCI signaling triggering transmission of a CSI-RS set is transmitted, and

$$\frac{K}{{N}_{one}}$$

CSI-RS resources are transmitted in each slot, or in other words,

$$⌈ \frac{K}{{N}_{one}} ⌉ = 4$$

CSI-RS resources are transmitted in the third slot, and

$$K - ( {N}_{one} - 1 ) ⌈ \frac{K}{{N}_{one}} ⌉ = 4$$

CSI-RS resources are transmitted in the fourth slot.

In this implementation, “transmitting a reference signal resource in a time interval” refers to that the network device, by using the reference signal resource, transmits a reference signal associated with the reference signal resource in the time interval. And similar expressions have similar meanings, which shall not be enumerated herein any further.

In this embodiment, description is given by taking that the first configuration information is a bitmap of N bits as an example. However, this embodiment is not limited thereto, and the first configuration information may also be other forms of contents, as long as it is able to indicate one or more time intervals via the first configuration information indicates, and the one or more time intervals may be used for transmission of the reference signal resources configured in the reference signal resource set.

With the method of this embodiment, the network device transmits the first configuration information to the terminal equipment to indicate the reference signal resources configured in the reference signal resource set transmitted in one or more time intervals; wherein the reference signal resources are allocated in one or more time intervals. Hence, it may be ensured that when the number of aperiodic reference signal resources needed in one time of measurement is relatively large, reference signal resources in a reference signal resource set being transmitted within multiple time intervals may be indicated. And the terminal equipment may select appropriate reference signal resources based on the configuration of the network device and report the reference signal resource indicators (CRIs, CSI-RS resource indicator) to the network device.

The embodiment of this disclosure provides an indication method for a new aperiodic resource transmission mechanism that supports the transmission of multiple aperiodic reference signal resources triggered by a trigger signaling spanning multiple time intervals, which is advantageous to beam management in a case where a reception ability of the terminal equipment is limited. The method may be applicable to multiple application scenarios, and the terminal equipment may determine different application scenarios via different configuration parameters of a higher layer, and determine the length of a feedback CRI.

### Embodiment 2

The embodiment of this disclosure provides a method for reporting reference signal resource indicators (CRIs).

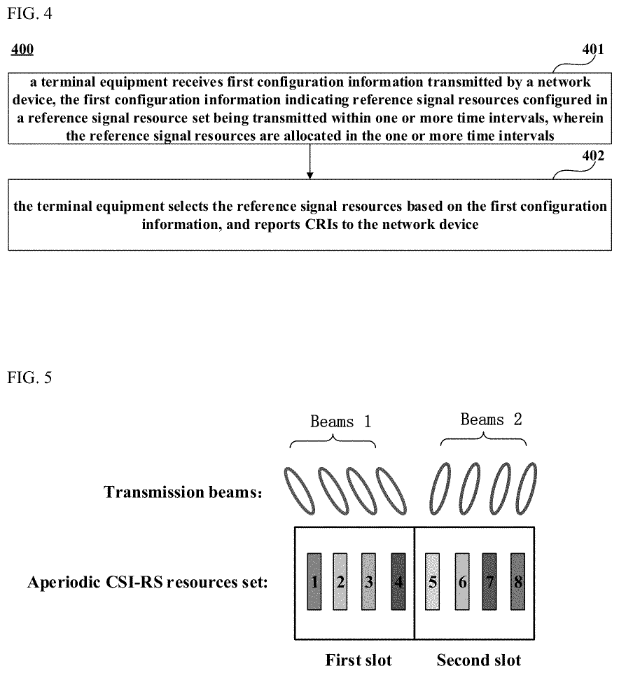

FIG. 4 is a schematic diagram of the method for reporting CRIs of the embodiment of this disclosure, in which a situation at a terminal equipment side is shown. This method is processing at the terminal equipment side corresponding to the method of Embodiment 1, with contents identical to those in Embodiment 1 being not going to be described herein any further. As shown in FIG. 4, a method 400 for reporting reference signal resource indicators (CRIs) includes:

step 401: a terminal equipment receives first configuration information transmitted by a network device, the first configuration information indicating reference signal resources configured in a reference signal resource set being transmitted within one or more time intervals, wherein the reference signal resources are allocated in the one or more time intervals; and

step 402: the terminal equipment selects the reference signal resources based on the first configuration information, and reports CRIs to the network device.

In this embodiment, the terminal equipment may select an appropriate reference signal resource based on the first configuration information transmitted by the network device, and report the CRI to the network device.

In this embodiment, manners in which the terminal equipment selects the reference signal resource are different for different application scenarios. Following description shall be given for different application scenarios, respectively.

In an application scenario, the network device may also configure a first parameter for the terminal equipment. When the first parameter is optional, in step 402, the terminal equipment may select the reference signal resource for reporting the CRI according to whether the network device configures the first parameter or a configuration state (ON or OFF) of the first parameter and the time interval indicated by the first configuration information in which the reference signal resources configured in the reference signal resource set are transmitted.

For example, if the network device does not configure the first parameter for the terminal equipment, when the terminal equipment needs to report the CRI, it selects one or more reference signal resources by measuring the reference signal resources configured in the reference signal resource set to report the CRI, and the length of a CRI is of ┌log K┐ bits. In this example, the time interval in which the above reference signal resources are transmitted, i.e. the above Nₒₙₑ, may be greater than 1, or may be equal to 1.

Taking FIG. 3 as an example, if the network device does not configure the first parameter for the terminal equipment, the terminal equipment may select any one or more of 1-8 reference signal resources by measurement for reporting the CRI, the length of a CRI being of ┌log 8┐ bits.

For another example, if the network device configures the first parameter for the terminal equipment, the first parameter is configured to be in an enabled state (ON) and the number of time intervals in which the above reference signal resources are transmitted is Nₒₙₑ>1, the terminal equipment deems that downlink spatial domain transmission filters (transmission beams) used by the network device in transmitting the reference signal resources within a time interval are identical and downlink spatial domain transmission filters (transmission beams) used in transmitting the reference signal resources within different time intervals are different. Hence, when the terminal equipment needs to report the CRI, it may select reference signal resources in one or more time intervals from different time intervals in which the reference signal resources are transmitted to report the CRI, and the length of a CRI is of ┌log Nₒₙₑ┐ bits.

Take FIG. 5 as an example. In the example of FIG. 5, the aperiodic CSI-RS resource set includes eight CSI-RS resources, and the eight CSI-RS resources are allocated in two slots (a first slot and a second slot) for transmission, that is, Nₒₙₑ=2. If the network device configures the first parameter for the terminal equipment and the first parameter is configured to be ON, as beams (denoted as beams 1) used by CSI-RS resources in the first slot are identical, the terminal equipment may arbitrarily select a CSI-RS resource from the first slot to report the CRI. Likewise, as beams (denoted as beams 2) used by CSI-RS resources in the second slot are identical, the terminal equipment may arbitrarily select a CSI-RS resource from the second slot to report the CRI. Likewise, the terminal equipment may also arbitrarily select a CSI-RS resource respectively from the first slot and the second slot to report the CRI. In addition, the length of a CRI is of ┌log Nₒₙₑ┐=┌log 2┐ bits.

In this example, the network device trains different transmission beams (spatial domain transmission filters) in different slots, and the terminal equipment trains different reception beams (spatial domain reception filters) in the same slot. The CRI is selection for transmission beams, that is, selecting transmission beams used by one or more slots to report the CRI to the network device.

For another example, if the network device configures the first parameter for the terminal equipment, the first parameter is configured to be in a disabled state (OFF) and the number of time intervals in which the above reference signal resources are transmitted is Nₒₙₑ>1, the terminal equipment does not deem that downlink spatial domain transmission filters (transmission beams) used by the network device in transmitting the reference signal resources in a time interval are all identical, and the terminal equipment deems that orders of downlink spatial domain transmission filters (transmission beams) used by the network device in different time intervals are identical; and when the terminal equipment needs to report the CRI, it may select one or more reference signal resources from reference signal resources transmitted in one time interval to report the CRI, the length of a CRI being of

$$⌈ log ⌈ \frac{K}{{N}_{one}} ⌉ ⌉$$

bits.

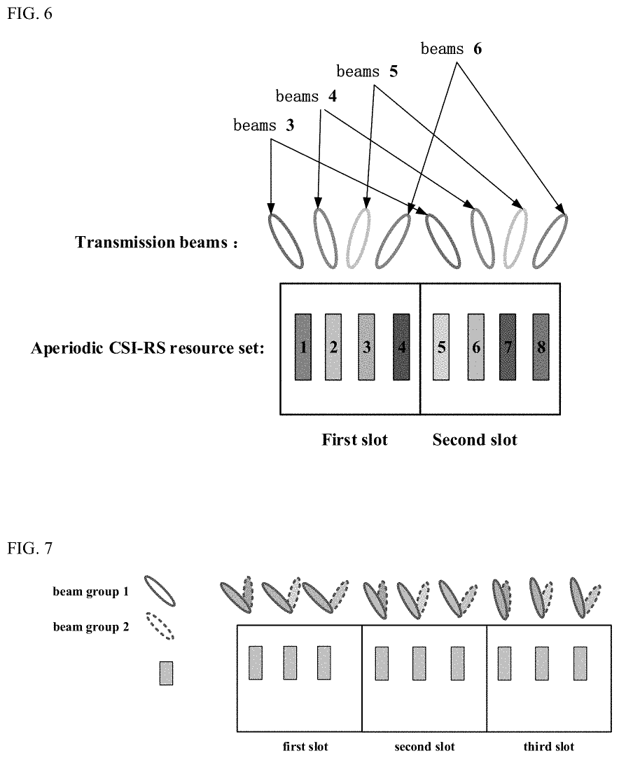

Take FIG. 6 as an example. In the example of FIG. 6, the aperiodic CSI-RS resource set includes eight CSI-RS resources, and the eight CSI-RS resources are allocated in two slots (a first slot and a second slot) for transmission, that is, Nₒₙₑ=2. If the network device configures the first parameter for the terminal equipment and the first parameter is configured to be OFF, beams (denoted as beams 3-6) used by the network device in transmitting the CSI-RS resources in each slot are different, but in different slots, orders of beams used by the network device in transmitting the CSI-RS resources are identical, that is, CSI-RS resources 1 and 5 use a beam 3, CSI-RS resources 2 and 6 use a beam 4, CSI-RS resources 3 and 7 use a beam 5, and CSI-RS resources 4 and 8 use a beam 6. At this moment, as beams used by CSI-RS resources in each slot in which CSI-RS resources are transmitted are identical, the terminal equipment may select one or more CSI-RS resource from the first slot or the second slot to report the CRI. Furthermore, the length of a CRI is of

$$⌈ log ⌈ \frac{K}{{N}_{o n e}} ⌉ ⌉ = ⌈ log ⌈ \frac{8}{2} ⌉ ⌉ = ⌈ log 4 ⌉$$

bits.

In this example, the network device trains different transmission beams in the same slot, and the terminal equipment trains different reception beams (spatial domain reception filters) in different slots.

In this application scenario, when the first parameter is mandatory, in step 402, the terminal equipment may select a reference signal resource for reporting the CRI according to a configuration state of the first parameter (ON or OFF) and a time interval used for transmitting the reference signal resources configured in the signal resource set indicated by the above first configuration information.

For example, if the network device configures the first parameter for the terminal equipment, the first parameter is configured to be in an enabled state (ON) and the number of time intervals in which the above reference signal resources are transmitted is Nₒₙₑ>1, the terminal equipment deems that downlink spatial domain transmission filters (transmission beams) used by the network device in transmitting the reference signal resources within a time interval are identical and downlink spatial domain transmission filters (transmission beams) used by the reference signal resources transmitted in different time intervals are different. Hence, when the terminal equipment needs to report the CRI, it may select reference signal resources in one or more time intervals from different time intervals in which the reference signal resources are transmitted to report the CRI, the length of a CRI being of ┌log Nₒₙₑ┐ bits. This case is same as the case of the optional configuration scenario where the first parameter is set to be ON and Nₒₙₑ>1. Reference may be made to FIG. 5 for a particular example, which shall not be described herein any further.

For another example, if the network device configures the first parameter for the terminal equipment and the first parameter is configured to be in a disabled state (OFF), when the terminal equipment needs to report the CRI, it may select one or more reference signal resources from the reference signal resources configured in the reference signal resource set to report the CRI, the length of a CRI being of ┌log K┐ bits. This case is same as the case of the optional configuration scenario where the network device does not configure the first parameter for the terminal equipment. Reference may be made to FIG. 3 for a particular example, which shall not be described herein any further.

In this application scenario, no matter whether the first parameter is optional or mandatory, if the network device configures the first parameter for the terminal equipment, the first parameter is configured to be in the enabled state (ON) and the number of the time intervals in which the reference signal resources are transmitted is Nₒₙₑ=1, and the terminal equipment deems that the downlink spatial domain transmission filters used by the network device in transmitting the reference signal resources configured in the reference signal resource set are all identical. If the CRI is not included in a reporting configuration linked to the reference signal resource set, the terminal equipment does not report the CRI.

In this application scenario, no matter whether the first parameter is optional or mandatory, if the network device configures the first parameter for the terminal equipment, the first parameter is configured to be in the disabled state (OFF) and the number of the time intervals in which the reference signal resources are transmitted is Nₒₙₑ=1, and the terminal equipment does not deem that the downlink spatial domain transmission filters used by the network device in transmitting the reference signal resources configured in the reference signal resource set are all identical; and when the terminal equipment needs to report the CRI, it may select one or more reference signal resources from the reference signal resources configured in the reference signal resource set to report the CRI, the length of a CRI being of ┌log K┐ bits. This case is same as the cases of the optional configuration scenario where the network device does not configure the first parameter for the terminal equipment and the optional configuration scenario where the network device configures the first parameter in the OFF state for the terminal equipment. Reference may be made to FIG. 3 for a particular example, which shall not be described herein any further.

In this application scenario, the above first parameter may be a higher-layer configuration parameter repetition; however, this embodiment is not limited thereto, and the first parameter may also be other parameters that may be used to indicate cases of beams transmitting CSI-RS resources.

In another scenario, the network device may also configure a second parameter for the terminal equipment. When the second parameter is configured to be enabled (ON), it indicates that the network device simultaneously transmits reference signal resources by using multiple groups of downlink spatial domain transmission filters, report of a CRI is a group-based beam (downlink spatial domain transmission filter) report, and the terminal equipment needs to report multiple beams received at the same time.

In this application scenario, in an example, the second parameter is linked to a reference signal resource set in a reference signal resource configuration. For example, the second parameter is only linked to the above-described reference signal resource set, and the terminal equipment may select a reference signal resource according to a configuration state (ON or OFF) of the first parameter configured by the network device and the time interval in which the reference signal resources configured in the reference signal resource set are transmitted indicated by the above first configuration information, and report the CRI to the network device.

For example, if the network device configures the first parameter for the terminal equipment and the first parameter is configured to be in the enabled state (ON), the terminal equipment deems that downlink spatial domain transmission filters in the same group in groups of downlink spatial domain transmission filters used by the network device are all identical, and in a reporting configuration linked to the reference signal resource set, the CRI is not included, and the terminal equipment does not report the CRI.

In this example, the process is used for training of reception beams at the terminal equipment side in a group-based beam management process 3.

For another example, if the network device configures the first parameter for the terminal equipment and the first parameter is configured to be in the disabled state (OFF), the terminal equipment does not deem that the groups of downlink spatial domain transmission filters (transmission beams) used by the network device in transmitting the reference signal resources in the reference signal resource set are all identical. For example, the terminal equipment deems that within a time interval, one group of downlink spatial domain transmission filters (one group of beams) used in transmitting reference signal resources are different, and other groups of downlink spatial domain transmission filters (other groups of beams) used in transmitting reference signal resources are all identical; between different time intervals, one group of downlink spatial domain transmission filters (one group of beams) are all identical, and other groups of downlink spatial domain transmission filters (other groups of beams) are different. When the terminal equipment needs to report the CRI, it reports one or more CRIs respectively for the above one group and the other groups of downlink spatial domain transmission filters; where, the length of at least one CRI

$$⌈ log ⌈ \frac{K}{{N}_{o n e}} ⌉ ⌉$$

is bits, and the length of at least one CRI is ┌log Nₒₙₑ┐ bits.

Take FIG. 7 as an example. In the example of FIG. 7, the aperiodic CSI-RS resource set 1 includes nine CSI-RS resources, i.e. K=9, and the nine CSI-RS resources are allocated in three slots (a first slot, a second slot and a third slot) for transmission, that is, Nₒₙₑ=3. In the first slot, three beams in beam group 1 are identical, and three beams in beam group 2 are different; in the second slot, three beams in beam group 1 are identical, but are different from the three beams in beam group 1 in the first slot, and three beams in beam group 2 are different, but are respectively identical to the three beams in beam group 2 in the first slot; in the third slot, three beams in beam group 1 are identical, but are all different from the three beams in beam group 1 in the first slot and the three beams in beam group 1 in the second slot, and three beams in beam group 2 are different, but are respectively identical to the three beams in beam group 2 in the first slot and the three beams in beam group 2 in the second slot. Then, the terminal equipment reports one or more CRIs for each group of beams; where, the length of at least one CRI is

$$⌈ log ⌈ \frac{K}{{N}_{o n e}} ⌉ ⌉ = ⌈ log ⌈ \frac{9}{3} ⌉ ⌉ = ⌈ log 3 ⌉$$

bits, and the length of at least one CRI is ┌log Nₒₙₑ┐=┌log 3┐ bits.

In this example, the process is used for training of transmission beams at the network device side in a group-based beam management process 2, wherein beam training in one slot is for one group of beams, and beam training between slots is for another group of beams.

In this application scenario, in another example, the second parameter is linked to multiple reference signal resource sets in one or more resource configurations of reference signal resources. For example, the second parameter is linked to the above multiple reference signal resource sets, that is, the above reference signal resource sets are multiple, and are all linked to the second parameter. Then, the terminal equipment may select reference signal resources to report the CRI to the network device according to a configuration state (ON or OFF) of the first parameter configured by the network device for the reference signal resource sets linked to the second parameter and the time interval used for transmitting the reference signal resources configured in the reference signal resource set indicated by the above first configuration information.

For example, if the first parameter configured by the network device for all the reference signal resource sets linked to the second parameter is configured to be in the enabled state (ON), the terminal equipment deems that downlink spatial domain transmission filters in the same group of the groups of downlink spatial domain transmission filters used by the network device in transmitting the reference signal resources are all identical. In reporting configuration linked to the reference signal resource sets, no CRI is included, and the terminal equipment does not report the CRI.

In this example, the process is used for training of reception beams at the terminal equipment side in a group-based beam management process 3.

For another example, if in first parameters configured by the network device for all the reference signal resource sets linked to the second parameter, a first parameter of at least one reference signal resource set is configured to be in the enabled state (ON) and a first parameter of at least one reference signal resource set is configured to be in the disabled state (OFF), the terminal equipment respectively reports the CRI for the reference signal resource sets. For example, the terminal equipment may form a feedback report of measurement of the multiple reference signal resource sets, contents of the feedback report including CRI feedback on the reference signal resource sets.

In this example, for a reference signal resource set of which the first parameter is configured to be in an enabled state (ON), the terminal equipment deems that in the reference signal resource set, downlink spatial domain transmission filters (transmission beams) used by reference signal resources in the same time interval are all identical, and downlink spatial domain transmission filters (transmission beams) used by reference signal resources in different time intervals are different. At this moment, a CRI needing to be reported by the terminal equipment is selection of a time interval, and when the terminal equipment needs to report the CRI, it may select one or more reference signal resources in the reference signal resource set configured to be in the enabled state (ON) transmitted in different time intervals to report the CRI, the length of a CRI being of ┌log Nₒₙₑ┐ bits.

In this example, for a reference signal resource set of which the first parameter is configured to be in a disabled state (OFF), the terminal equipment deems that in the reference signal resource set, downlink spatial domain transmission filters (transmission beams) used by reference signal resources in the same time interval are different, and orders of downlink spatial domain transmission filters (transmission beams) used by reference signal resources in different time intervals are identical. At this moment, a CRI needing to be reported by the terminal equipment is selection of reference signal resources in a time interval, and when the terminal equipment needs to report the CRI, it may select one or more reference signal resources in the reference signal resource set configured to be in the disabled state (OFF) transmitted in the same time interval to report the CRI, the length of a CRI being of

$$⌈ log ⌈ \frac{K}{{N}_{o n e}} ⌉ ⌉$$

bits.

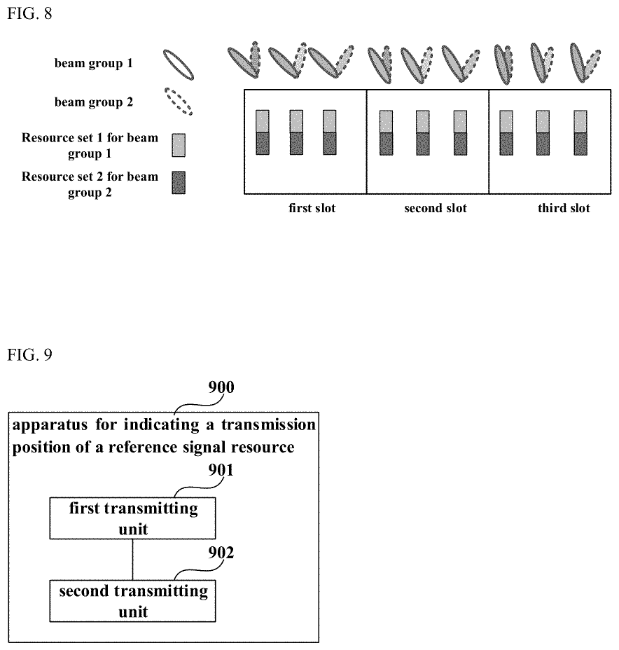

Take FIG. 8 as an example. In the example of FIG. 8, there are two aperiodic CSI-RS resource sets linked to the second parameter, which are resource set 1 and resource set 2, respectively. Resource set 1 is used for beam group 1, and resource set 2 is used for beam group 2. Resource set 1 and resource set 2 respectively include 9 CSI-RS resources, that is, K=9, which are allocated in three slots (a first slot, a second slot and a third slot), that is, Nₒₙₑ=3. In the first slot, the three beams in beam group 1 are identical, and the three beams in beam group 2 are different; in the second slot, the three beams in beam group 1 are identical, but are different from the three beams in beam group 1 in the first slot, and the three beams in beam group 2 are different, but are respectively identical to the three beams in beam group 2 in the first slot; and in the third slot, the three beams in beam group 1 are identical, but are different from the three beams in beam group 1 in the first slot and the three beams in beam group 1 in the second slot, and the three beams in beam group 2 are different, but are respectively identical to the three beams in beam group 2 in the first slot and the three beams in beam group 2 in the second slot. For the resource set of which the first parameter is configured to be ON, which is assumed as resource set 1, the terminal equipment selects one or more reference signal resources in resource set 1 transmitted in different slots to report the CRI, the length of a CRI being of ┌log Nₒₙₑ ┐=┌log 3┐ bits. And for the resource set of which the first parameter is configured to be OFF, which is assumed as resource set 2, the terminal equipment selects one or more reference signal resources in resource set 2 transmitted in the same slot to report the CRI, the length of a CRI being of

$$⌈ log ⌈ \frac{K}{{N}_{o n e}} ⌉ ⌉ = ⌈ log ⌈ \frac{9}{3} ⌉ ⌉ = ⌈ log 3 ⌉$$

bits.

In this example, the process is used for training of transmission beams at the network device side in a group-based beam management process 2, wherein beam training in one slot is for one group of beams, and beam training between slots is for another group of beams.

In this application scenario, the above second parameter may be a higher-layer configuration parameter groupBasedBeamReporting; however, this embodiment is not limited thereto, and the second parameter may also be other configuration parameters in higher-layer configuration that may be used to indicate group-based beam report.

With the method of the embodiment of this disclosure, the terminal equipment may select appropriate reference signal resources based on the configuration of the network device and report the reference signal resource indicators (CRIs) to the network device, and the terminal equipment may determine different application scenarios via different configurations of the higher layers, and determine the length of a feedback CRI.

### Embodiment 3

The embodiment of this disclosure provides an apparatus for indicating a transmission position of a reference signal resource. The apparatus may be, for example, a network device, and may also be one or more components or assemblies configured in a network device. As principles of the apparatus are similar to that of the method in Embodiment 1, reference may be made to the implementation of the method in Embodiment 1 for implementation of the apparatus, with identical contents being not going to be described herein any further.

FIG. 9 is a schematic diagram of the apparatus for indicating a transmission position of a reference signal resource of the embodiment of this disclosure. As shown in FIG. 9, an apparatus 900 for indicating a transmission position of a reference signal resource includes:

a first transmitting unit 901 configured to transmit first configuration information to a terminal equipment, the first configuration information indicating reference signal resources configured in a reference signal resource set being transmitted within one or more time intervals, wherein the reference signal resources are allocated in the one or more time intervals.

In this embodiment, the reference signal resources are aperiodic channel state information reference signal resources, and the time intervals include at least one of the following: a slot, a frame, and a subframe.

In one implementation, the first configuration information is a bitmap of N bits, the N bits of the bitmap representing N consecutive time intervals starting from a time interval in which signaling triggering the transmission of the reference signal resource set is located, wherein bits in the bitmap set to be of predetermined values denote at least one reference signal resource configured in the reference signal resource set being transmitted within a time interval represented by the bits set to be of predetermined values.

In this implementation, the number of reference signal resources configured in the reference signal resource set being transmitted within the time interval represented by the bits set to be of predetermined values is:

$$\frac{K}{{N}_{o n e}} , or ⌈ \frac{K}{{N}_{o n e}} ⌉ and \text{/} or K - ( {N}_{one} - 1 ) ⌈ \frac{K}{{N}_{o n e}} ⌉ ;$$

where, K is the number of reference signal resources configured in the reference signal resource set, and Nₒₙₑ is the number of the bits in the bitmap set to be of predetermined values.

In the embodiment, as shown in FIG. 9, the apparatus 900 for indicating a transmission position of a reference signal resource may further include:

a second transmitting unit 902 configured to transmit second configuration information to the terminal equipment, the second configuration information indicating the reference signal resource set configured by the network device, and the second configuration information containing a configuration parameter triggering an offset; and the first configuration information is configuration for the configuration parameter triggering an offset.

It should be noted that the components or modules related to this disclosure are only described above. However, this disclosure is not limited thereto, and the apparatus 900 for indicating a transmission position of a reference signal resource may further include other components or modules, and reference may be made to related techniques for particulars of these components or modules.

Furthermore, for the sake of simplicity, connection relationships between the components or modules or signal profiles thereof are only illustrated in FIG. 9. However, it should be understood by those skilled in the art that such related techniques as bus connection may be adopted. And the above components or modules may be implemented by hardware, such as a processor, a memory, a transmitter, and a receiver, which are not limited in the embodiment of this disclosure.

It can be seen from the above embodiment that the network device transmits the first configuration information to the terminal equipment to indicate the reference signal resources configured in the reference signal resource set transmitted in one or more time intervals; wherein the reference signal resources are allocated in one or more time intervals. Hence, it may be ensured that when the number of aperiodic reference signal resources needed in one time of measurement is relatively large, reference signal resources in a reference signal resource set being transmitted within multiple time intervals may be indicated.

### Embodiment 4

The embodiment of this disclosure provides an apparatus for reporting CRIs. The apparatus may be, for example, a terminal equipment, and may also be one or more components or assemblies configured in a terminal equipment. As principles of the apparatus are similar to that of the method in Embodiment 2, reference may be made to the implementation of the method in Embodiment 2 for implementation of the apparatus, with identical contents being not going to be described herein any further.

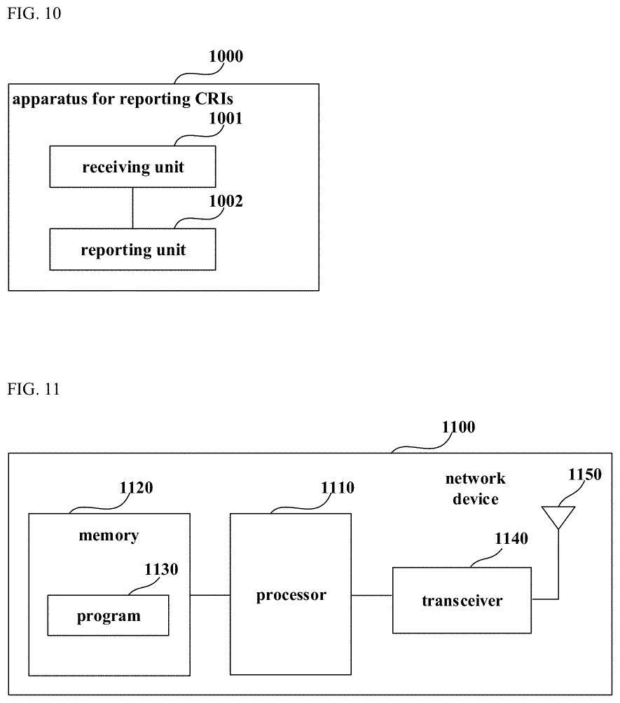

FIG. 10 is a schematic diagram of the apparatus for reporting CRIs of the embodiment of this disclosure. As shown in FIG. 10, an apparatus 1000 for reporting CRIs includes:

a receiving unit 1001 configured to receive first configuration information transmitted by a network device, the first configuration information indicating reference signal resources configured in a reference signal resource set being transmitted within one or more time intervals, wherein the reference signal resources are allocated in the one or more time intervals; and

a reporting unit 1002 configured to select the reference signal resources based on the first configuration information, and report CRIs to the network device.

In one implementation, if the network device does not configure the terminal equipment with a first parameter of an optional configuration, the reporting unit 1002 selects one or more reference signal resources from the reference signal resources configured in the reference signal resource set to report the CRIs, the length of one CRI being ┌log K┐ bits, where, K is the number of the reference signal resources configured in the reference signal resource set.

In one implementation, if the network device configures the terminal equipment with a first parameter of an optional configuration or a mandatory configuration, the first parameter being configured to be in an enabled state (ON), and the number of time intervals for transmitting the reference signal resources being greater than 1, the terminal equipment deems that downlink spatial domain transmission filters used by the network device in transmitting the reference signal resources in a time interval are all identical, and downlink spatial domain transmission filters used by reference signal resources transmitted in different time intervals are different, the reporting unit 1002 selects reference signal resources at one or more time intervals from the different time intervals for transmitting the reference signal resources to report the CRIs, and the length of one CRI is ┌log Nₒₙₑ┐ bits, where, Nₒₙₑ is the number of the time intervals.

In one implementation, if the network device configures the terminal equipment with a first parameter of an optional configuration, the first parameter being configured to be in a disabled state (OFF), and the number of time intervals for transmitting the reference signal resources being greater than 1, the terminal equipment does not deem that downlink spatial domain transmission filters used by the network device in transmitting the reference signal resources in one time interval are all identical, and the terminal equipment deems that orders of downlink spatial domain transmission filters used by the network device in different time intervals are identical, the reporting unit 1002 selects one or more reference signal resources from the reference signal resources transmitted within one time interval to report the CRIs, and the length of one CRI is

$$⌈ log ⌈ \frac{K}{{N}_{o n e}} ⌉ ⌉$$

bits, where, K is the number of the reference signal resources configured in the reference signal resource set, and Nₒₙₑ is the number of the time intervals.

In one implementation, if the network device configures the terminal equipment with a first parameter of a mandatory configuration, the first parameter being configured to be in a disabled state (OFF), the reporting unit 1002 selects one or more reference signal resources from the reference signal resources configured in the reference signal resource set to report the CRIs, and the length of one CRI is ┌log K┐ bits, where, K is the number of the reference signal resources configured in the reference signal resource set.

In one implementation, if the network device configures the terminal equipment with a first parameter of an optional configuration or a mandatory configuration, the first parameter being configured to be in an enabled state (ON) and the number of time intervals for transmitting the reference signal resources being equal to 1, the reporting unit 1002 deems that downlink spatial domain transmission filters used by the network device in the reference signal resources configured in the reference signal resource set are all identical, and the terminal equipment does not report the reference signal resource indicators (CRIs).

In one implementation, if the network device configures the terminal equipment with a first parameter of an optional configuration or a mandatory configuration, the first parameter being configured to be in a disabled state (OFF) and the number of time intervals for transmitting the reference signal resources being equal to 1, the terminal equipment does not deem that downlink spatial domain transmission filters used by the network device in transmitting the reference signal resources configured in the reference signal resource set are all identical, and the reporting unit 1002 selects one or more reference signal resources from the reference signal resources configured in the reference signal resource set to report the reference signal resource indicators (CRIs), and the length of one CRI is ┌log K┐ bits, where, K is the number of the reference signal resources configured in the reference signal resource set.

In one implementation, if the network device configures the terminal equipment with a second parameter, the second parameter being configured to be in an enabled state (ON), and indicating that the network device transmits the reference signal resources by using multiple groups of downlink spatial domain transmission filters, and the second parameter being linked to the reference signal resource set, the reporting unit 1002 reports the multiple reference signal resource indicators (CRIs) based on the first configuration information.

In this implementation, if the network device configures the terminal equipment with a first parameter, the first parameter being configured to be in an enabled state (ON), the terminal equipment deems that downlink spatial domain transmission filters in the same group in the groups of downlink spatial domain transmission filters used by the network device in transmitting the reference signal resources are all identical, and the reporting unit 1002 does not report the reference signal resource indicators (CRIs).

In this implementation, if the network device configures the terminal equipment with the first parameter, the first parameter being configured to be in a disabled state (OFF), the terminal equipment deems that, within one time interval, one group of downlink spatial domain transmission filters used for transmitting the reference signal resources are different and other groups of downlink spatial domain transmission filters used for transmitting the reference signal resources are all identical, between different time intervals, the one group of downlink spatial domain transmission filters are all identical and the other groups of downlink spatial domain transmission filters are different, and the reporting unit 1002 reports one or more reference signal resource indicators (CRIs) respectively for the one group of downlink spatial domain transmission filters and the other groups of downlink spatial domain transmission filters; wherein, the length of at least one of the CRIs is

$$⌈ log ⌈ \frac{K}{{N}_{o n e}} ⌉ ⌉$$

bits, and the length of at least one of the CRIs is ┌log Nₒₙₑ┐ bits; where, K is the number of the reference signal resources configured in the reference signal resource set, and Nₒₙₑ is the number of the time intervals.

In this implementation, the second parameter is further linked to other reference signal resource sets, the network device transmits reference signal resources configured in different reference signal resource sets by using different groups of downlink spatial domain transmission filter, and if first parameters configured by the network device for all reference signal resource sets linked to the second parameter are all configured to be in an enabled state (ON), the terminal equipment deems that downlink spatial domain transmission filters in the same group of the groups of downlink spatial domain transmission filters used by the network device for transmitting the reference signal resources are all identical, the reporting unit 1002 does not report the reference signal resource indicators (CRIs).

In this implementation, the second parameter is further linked to other reference signal resource sets, and if in first parameters configured by the network device for all reference signal resource sets linked to the second parameter, a first parameter of at least one reference signal resource set is configured to be in an enabled state (ON), and a first parameter of at least one reference signal resource set is configured to be in a disabled state (OFF), the reporting unit 1002 reports the reference signal resource indicators (CRIs) respectively for the reference signal resource sets.

For the reference signal resource sets of which the first parameters are configured to be in the enabled state (ON), the terminal equipment deems that downlink spatial domain transmission filters used by reference signal resources in the same time interval in the reference signal resource set are all identical, and downlink spatial domain transmission filters used by reference signal resources in different time intervals in the reference signal resource set are different, and the reporting unit 1002 selects one or more reference signal resources in the reference signal resource sets configured to be in the enabled state (ON) transmitted at different time intervals to report the reference signal resource indicators (CRIs), the length of one CRI being ┌log Nₒₙₑ ┐ bits, where, Nₒₙₑ is the number of the time intervals;

and for the reference signal resource sets of which the first parameters are configured to be in the disabled state (OFF), the terminal equipment deems that downlink spatial domain transmission filters used by reference signal resources in the same time interval in the reference signal resource set are different, and orders of downlink spatial domain transmission filters used by reference signal resources in different time intervals in the reference signal resource set are identical, and the terminal equipment selects one or more reference signal resources in the reference signal resource sets configured to be in the disabled state (OFF) transmitted at the same time interval to report the reference signal resource indicators (CRIs), the length of one CRI being

$$⌈ log ⌈ \frac{K}{{N}_{o n e}} ⌉ ⌉$$

bits, where, K is the number of the reference signal resources configured in the reference signal resource sets, and Nₒₙₑ is the number of the time intervals.

In this embodiment, the above first parameter may be a higher-layer configuration parameter repetition, and the second parameter may be a high-layer configuration parameter groupBasedBeamReporting.

It can be seen from the above embodiment that the terminal equipment may select appropriate reference signal resources based on the configuration of the network device and report the reference signal resource indicators (CRIs) to the network device, and the terminal equipment may determine different application scenarios via different configurations parameters of the higher layers, and determine the length of a feedback CRI.

### Embodiment 5

The embodiment of this disclosure provides a communication system, and reference may be made to FIG. 1, with contents identical to those in embodiments 1-4 being not going to be described herein any further. In this embodiment, the communication system 100 may include:

a network device 101 configured with the apparatus 900 for indicating a transmission position of a reference signal resource as described in Embodiment 3; and

a terminal equipment 102 configured with the apparatus 1000 for reporting CRIs as described in Embodiment 4.

The embodiment of this disclosure further provides a network device, which may be, for example, a base station. However, this disclosure is not limited thereto, and it may also be another network device.

FIG. 11 is a schematic diagram of a structure of the network device of the embodiment of this disclosure. As shown in FIG. 11, a network device 1100 may include a processor 1110 (such as a central processing unit (CPU)) and a memory 1120, the memory 1120 being coupled to the processor 1110. The memory 1120 may store various data, and furthermore, it may store a program 1130 for data processing, and execute the program 1130 under control of the processor 1110.

For example, the processor 1110 may be configured to execute the program 1130 to carry out the method for indicating a transmission position of a reference signal resource as described in Embodiment 1. For example, the processor 1110 may be configured to execute the following control: transmitting first configuration information to a terminal equipment, the first configuration information indicating reference signal resources configured in a reference signal resource set being transmitted within one or more time intervals, wherein the reference signal resources are allocated in the one or more time intervals.

Furthermore, as shown in FIG. 11, the network device 1100 may include a transceiver 1140, and an antenna 1150, etc. Functions of the above components are similar to those in the related art, and shall not be described herein any further. It should be noted that the network device 1100 does not necessarily include all the parts shown in FIG. 11, and furthermore, the network device 1100 may include parts not shown in FIG. 11, and the related art may be referred to.

The embodiment of this disclosure further provides a terminal equipment, however, this disclosure is not limited thereto, and it may also be another equipment.

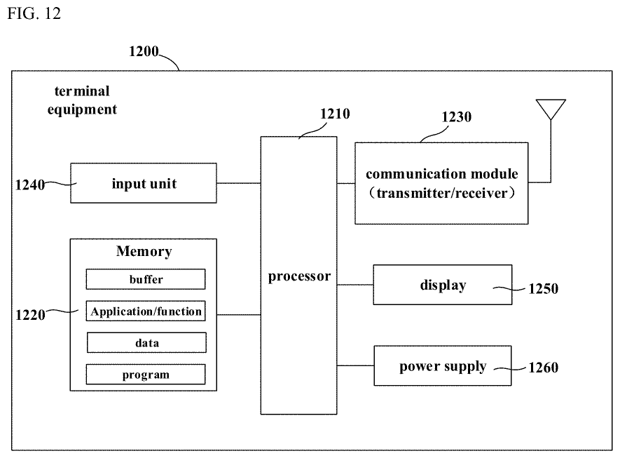

FIG. 12 is a schematic diagram of the terminal equipment of the embodiment of this disclosure. As shown in FIG. 12, a terminal equipment 1200 may include a processor 1210 and a memory 1220, the memory 1220 storing data and a program and being coupled to the processor 1210. It should be noted that his figure is illustrative only, and other types of structures may also be used, so as to supplement or replace this structure and achieve a telecommunications function or other functions.

For example, the processor 1210 may be configured to execute a program to carry out the method for reporting CRIs described in Embodiment 2. For example, the processor 1210 may be configured to execute the following control: receiving first configuration information transmitted by a network device, the first configuration information indicating reference signal resources configured in a reference signal resource set being transmitted within one or more time intervals, wherein the reference signal resources are allocated in the one or more time intervals; and selecting the reference signal resources based on the first configuration information, and reporting CRIs to the network device.

As shown in FIG. 12, the terminal equipment 1200 may further include a communication module 1230, an input unit 1240, a display 1250, and a power supply 1260; wherein functions of the above components are similar to those in the related art, which shall not be described herein any further. It should be noted that the terminal equipment 1200 does not necessarily include all the parts shown in FIG. 12, and the above components are not necessary. Furthermore, the terminal equipment 1200 may include parts not shown in FIG. 12, and the related art may be referred to.

An embodiment of the present disclosure provides a computer readable program, which, when executed in a network device, will cause the network device to carry out the method described in Embodiment 1.

An embodiment of this disclosure provides a computer storage medium, including a computer readable program, which will cause a network device to carry out the method described in Embodiment 1.

An embodiment of the present disclosure provides a computer readable program, which, when executed in a terminal equipment, will cause the terminal equipment to carry out the method as described in Embodiment 2.

An embodiment of the present disclosure provides a computer storage medium, including a computer readable program, which will cause a terminal equipment to carry out the method as described in Embodiment 2.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in FIG. 2. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. An apparatus for indicating a transmission position of a reference signal resource, configured in a network device, the apparatus comprising:
a first transmitting unit configured to transmit first configuration information to a terminal equipment, the first configuration information indicating reference signal resources configured in a reference signal resource set being transmitted within one or more time intervals, wherein the reference signal resources are allocated in the one or more time intervals.

2. The apparatus according to claim 1, wherein the reference signal resources are aperiodic channel state information reference signal resources, and the one or more time intervals comprise at least one of the following: a slot, a frame, and a subframe.

3. The apparatus according to claim 1, wherein the first configuration information is a bitmap of N bits, the N bits of the bitmap representing N consecutive time intervals starting from a time interval in which signaling triggering the transmission of the reference signal resource set is located, wherein bits in the bitmap set to be of predetermined values denote at least one reference signal resource configured in the reference signal resource set being transmitted within a time interval represented by the bits set to be of predetermined values.

4. The apparatus according to claim 3, wherein the number of reference signal resources configured in the reference signal resource set being transmitted within the time interval represented by the bits set to be of predetermined values is:
$$\frac{K}{{N}_{o n e}} , or ⌈ \frac{K}{{N}_{o n e}} ⌉ and \text{/} or K - ( {N}_{o n e} - 1 ) ⌈ \frac{K}{{N}_{o n e}} ⌉ ;$$
where, K is the number of reference signal resources configured in the reference signal resource set, and Nₒₙₑ is the number of the bits in the bitmap set to be of predetermined values.

5. The apparatus according to claim 3, wherein the apparatus further comprises:
a second transmitting unit configured to transmit second configuration information to the terminal equipment, the second configuration information indicating the reference signal resource set configured by the network device, and the second configuration information containing a configuration parameter triggering an offset;
and the first configuration information is configuration for the configuration parameter triggering an offset.

6. An apparatus for reporting reference signal resource indicators (CRIs), comprising:
a receiving unit configured to receive first configuration information transmitted by a network device, the first configuration information indicating reference signal resources configured in a reference signal resource set being transmitted within one or more time intervals, wherein the reference signal resources are allocated in the one or more time intervals; and
a reporting unit configured to select the reference signal resources based on the first configuration information, and report CRIs to the network device.

7. The apparatus according to claim 6, wherein if the network device does not configure the terminal equipment with a first parameter of an optional configuration, the reporting unit selects one or more reference signal resources from the reference signal resources configured in the reference signal resource set to report the CRIs, and the length of one CRI is ┌log K┐ bits, where, K is the number of the reference signal resources configured in the reference signal resource set.

8. The apparatus according to claim 6, wherein if the network device configures the terminal equipment with a first parameter of an optional configuration or a mandatory configuration, the first parameter being configured to be in an enabled state (ON), and the number of time intervals for transmitting the reference signal resources being greater than 1, the reporting unit selects reference signal resources at one or more time intervals from the different time intervals for transmitting the reference signal resources to report the CRIs, and the length of one CRI is ┌log Nₒₙₑ┐ bits, where, Nₒₙₑ is the number of the time intervals.

9. The apparatus according to claim 6, wherein if the network device configures the terminal equipment with a first parameter of an optional configuration, the first parameter being configured to be in a disabled state (OFF), and the number of time intervals for transmitting the reference signal resources being greater than 1, the reporting unit selects one or more reference signal resources from the reference signal resources transmitted within one time interval to report the CRIs, and the length of one CRI is
$$⌈ log ⌈ \frac{K}{{N}_{o n e}} ⌉ ⌉$$
bits, where, K is the number of the reference signal resources configured in the reference signal resource set, and Nₒₙₑ is the number of the time intervals.

10. The apparatus according to claim 6, wherein if the network device configures the terminal equipment with a first parameter of a mandatory configuration, the first parameter being configured to be in an disabled state (OFF), the reporting unit selects one or more reference signal resources from the reference signal resources configured in the reference signal resource set to report the CRIs, and the length of one CRI is ┌log K┐ bits, where, K is the number of the reference signal resources configured in the reference signal resource set.

11. The apparatus according to claim 6, wherein if the network device configures the terminal equipment with a first parameter of an optional configuration or a mandatory configuration, the first parameter being configured to be in an enabled state (ON) and the number of time intervals for transmitting the reference signal resources being equal to 1, the reporting unit does not report the CRIs.

12. The apparatus according to claim 6, wherein if the network device configures the terminal equipment with a first parameter of an optional configuration or a mandatory configuration, the first parameter being configured to be in a disabled state (OFF) and the number of time intervals for transmitting the reference signal resources being equal to 1, the reporting unit selects one or more reference signal resources from the reference signal resources configured in the reference signal resource set to report the CRIs, and the length of one CRI is ┌log K┐ bits, where, K is the number of the reference signal resources configured in the reference signal resource set.

13. The apparatus according to claim 7, wherein the first parameter is a high-layer configuration parameter repetition.

14. The apparatus according to claim 6, wherein if the network device configures the terminal equipment with a second parameter, the second parameter being configured to be in an enabled state (ON), and indicating that the network device transmits the reference signal resources by using multiple groups of downlink spatial domain transmission filters, and the second parameter being linked to the reference signal resource set, the reporting unit reports multiple CRIs based on the first configuration information.

15. The apparatus according to claim 14, wherein if the network device configures the terminal equipment with a first parameter, the first parameter being configured to be in an enabled state (ON), the reporting unit does not report the CRIs.

16. The apparatus according to claim 14, wherein if the network device configures the terminal equipment with the first parameter, and the first parameter being configured to be in a disabled state (OFF), the terminal equipment deems that, within one time interval, one group of downlink spatial domain transmission filters used for transmitting the reference signal resources are different and other groups of downlink spatial domain transmission filters used for transmitting the reference signal resources are identical, between different time intervals, the one group of downlink spatial domain transmission filters are identical and the other groups of downlink spatial domain transmission filters are different, and the reporting unit reports one or more CRIs respectively for the one group of downlink spatial domain transmission filters and the other groups of downlink spatial domain transmission filters; wherein, the length of at least one of the CRIs is
$$⌈ log ⌈ \frac{K}{{N}_{o n e}} ⌉ ⌉ ,$$
and the length of at least one of the CRIs is ┌log Nₒₙₑ┐; where, K is the number of the reference signal resources configured in the reference signal resource set, and Nₒₙₑ is the number of the time intervals.

17. The apparatus according to claim 14, wherein the second parameter is further linked to other reference signal resource sets, the network device transmits reference signal resources configured in different reference signal resource sets by using different groups of downlink spatial domain transmission filter, and if first parameters configured by the network device for all reference signal resource sets linked to the second parameter are all configured to be in an enabled state (ON), the reporting unit does not report the CRIs.

18. The apparatus according to claim 14, wherein the second parameter is further linked to other reference signal resource sets, and if in first parameters configured by the network device for all reference signal resource sets linked with the second parameter, a first parameter of at least one reference signal resource set is configured to be in an enabled state (ON), a first parameter of at least one reference signal resource set is configured to be in an disabled state (OFF), the reporting unit reports the CRIs respectively for the reference signal resource sets.

19. The apparatus according to claim 18, wherein,
for the reference signal resource sets of which the first parameters are configured to be in the enabled state (ON), the reporting unit selects one or more reference signal resources in the reference signal resource sets configured to be in the enabled state (ON) transmitted at different time intervals to report the CRIs, the length of one CRI being ┌log Nₒₙₑ ┐ bits, where, Nₒₙₑ is the number of the time intervals;
and for the reference signal resource sets of which the first parameters are configured to be in the disabled state (OFF), the reporting unit selects one or more reference signal resources in the reference signal resource sets configured to be in the disabled state (OFF) transmitted at the same time interval to report the CRIs, the length of one CRI being
$$⌈ log ⌈ \frac{K}{{N}_{o n e}} ⌉ ⌉$$
bits, where, K is the number of the reference signal resources configured in the reference signal resource sets, and Nₒₙₑ is the number of the time intervals.

20. The apparatus according to claim 14, wherein the second parameter is a high-layer configuration parameter groupBasedBeamReporting.
